(19) United States
(12) Patent Application Publication
(10) Pub. No.: US 2009/0058648 A1
(43) Pub. Date: Mar. 5, 2009

(54) METHODS AND SYSTEMS OF USING RFID TAGS IN EMERGENCY SITUATIONS

(75) Inventor: John R. Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: MICRON TECHNOLOGY, INC., BOISE, ID (US)

(21) Appl. No.: 11/846,838

(22) Filed: Aug. 29, 2007

(51) Int. Cl. G08B 13/14

(52) U.S. Cl. 340/572.1

(57) ABSTRACT

Methods and systems of using RFID tags in emergency situations. At least some of the illustrative embodiments are methods comprising writing emergency information to a radio frequency identification (RFID) tag, and enabling a first responder to read the emergency information in an emergency situation.

### BACKGROUND

1. Field

At least some of the various embodiments are directed to radio frequency identification (RFID) readers and RFID tags to convey information useful to a first responder while responding to an emergency.

2. Description of the Related Art

Emergency responders often encounter situations where they have a very limited amount of information to help them act and respond to emergency situations. For example, fire fighters may be unfamiliar with the structural layout of a building, or first responders may arrive at the scene of an accident involving dangerous chemicals, with little or no information regarding which chemicals are involved, and proper equipment and procedures for managing the accident.

### BRIEF DESCRIPTION OF THE DRAWINGS

For a detailed description of various embodiments, reference will now be made to the accompanying drawings in which:

FIG. 1 shows a radio frequency identification (RFID) system in accordance with at least some embodiments;

FIG. 2 shows RFID system placement in accordance with at least some embodiments;

FIG. 3 shows a method in accordance with at least some embodiments; and

FIG. 4 shows a method in accordance with at least some embodiments.

### NOTATION AND NOMENCLATURE

Certain terms are used throughout the following description and claims to refer to particular system components. As one skilled in the art will appreciate, design and manufacturing companies may refer to the same component by different names. This document does not intend to distinguish between components that differ in name but not function. In the following discussion and in the claims, the terms “including” and “comprising” are used in an open-ended fashion, and thus should be interpreted to mean “including, but not limited to . . . . ”

Also, the term “couple” or “couples” is intended to mean either an indirect or direct connection. Thus, if a first device couples to a second device, that connection may be through a direct connection or through an indirect connection via other intermediate devices and connections. Moreover, the term “system” means “one or more components” combined together. Thus, a system can comprise an “entire system,” “subsystems” within the system, a radio frequency identification (RFID) tag, a RFID reader, or any other device comprising one or more components.

Finally, the term “first responder” or “first responders” refer to emergency personnel, such as fire fighters, police officers, emergency medical technicians, and bomb squad technicians.

### DETAILED DESCRIPTION OF DISCLOSED EMBODIMENTS

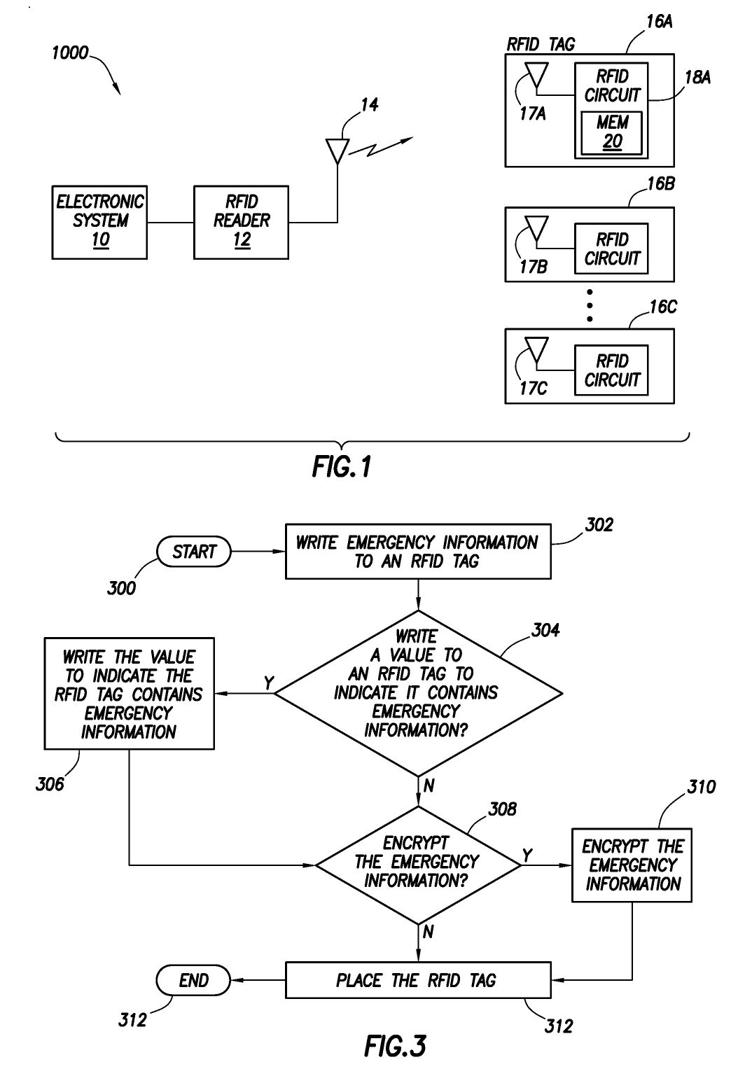

FIG. 1 illustrates a system 1000 in accordance with at least some embodiments. In particular, system 1000 comprises an electronic system 10 (e.g. a computer system) coupled to a radio frequency identification (RFID) reader 12. The RFID reader 12 may be equivalently referred as an interrogator. By way of antenna 14, the RFID reader 12 communicates with one or more RFID tags 16A-16C proximate to the RFID reader (i e., within communication range).

Considering a single RFID tag 16A (but the description equally applicable to all the RFID tags 16A-16C), RFID tag 16A comprises a tag antenna 17A which couples to an RFID circuit 18A. The RFID circuit 18A implements in hardware (or a combination of hardware and software) various state machines, microprocessors, logic or other circuits to enable the RFID circuit to receive signals from the RFID reader, and to respond to those signals in accordance with the various embodiments. The RFID circuit 18A further comprises a tag memory 20 within which the data payload of the RFID tag may be stored (e.g. information useful to a first responder in an emergency situation).

A communication sent by the RFID reader 12 is received by tag antenna 17A, and passed to the RFID circuit 18A. In response to the communication, the RFID circuit 18 transmits to the RFID reader 12 the response (e.g. the electronic product code, user defined data and kill passwords) using the tag antenna 17A. The RFID reader 12 passes data obtained from the various RFID tags 16 to the electronic system 10. The electronic system 10 may couple to the RFID reader by any suitable system, including over the Internet, and/or through other computers and computer networks. Using data obtained from the RFID reader 12, the electronic system may perform a variety of functions (e.g. the electronic system 10, based on the data received from the RFID tags 16, may identify and provide information useful to a first responder in an emergency situation).

There are several types of RFID tags operable in the illustrative system 1000. For example, RFID tags may be active tags, meaning each RFID tag comprises its own internal battery or other power source, and may include an active RF transmitter and/or RF beacon. Using power from the internal power source, an active RFID tag monitors for signals from the RFID reader 12. When an interrogating signal directed to the RFID tag is sensed, the tag response may be tag-radiated radio frequency (RF) power (with a carrier modulated to represent the data or identification value) using power from the internal battery or power source. A semi-active tag may likewise have its own internal battery or power source, but a semi-active tag remains dormant (i.e., powered-off or in a low power state) most of the time. When an antenna of a semi-active tag receives an interrogating signal, the power received is used to wake or activate the semi-active tag, and a response (if any) comprising an identification value is sent by modulating the RF backscatter from the tag antenna, with the semi-active tag using power for internal operations from its internal battery or power source. In particular, the RFID reader 12 and antenna 14 continue to transmit power after the RFID tag is awake. While the RFID reader 12 transmits, the tag antenna 17 of the RFID tag 16 is selectively tuned and de-tuned with respect to the carrier frequency. When tuned, significant incident power is absorbed by the tag antenna 17. When de-tuned, significant power is reflected by the tag antenna 17 to the antenna 14 of the RFID reader 12. The data or identification value modulates the carrier to form the reflected or backscattered electromagnetic wave. The RFID reader 12 reads the data or identification value from the backscattered electromagnetic waves. Thus, in this specification and in the claims, the terms “transmitting” and “transmission” include not only sending from an antenna using internally sourced power, but also sending in the form of backscattered signals.

A third type of RFID tag is a passive tag, which, unlike active and semi-active RFID tags, has no internal battery or power source. The tag antenna 17 of the passive RFID tag receives an interrogating signal from the RFID reader, and the power extracted from the received interrogating signal is used to power the tag. Once powered or “awake,” the passive RFID tag may accept a command, send a response comprising a data or identification value, or both; however, like the semi-active tag the passive tag sends the response in the form of RF backscatter.

The various embodiments are directed to systems comprising RFID readers and RFID tags storing and conveying information that is useful to a first responder upon arriving at the scene of an emergency. Within these systems, emergency information is stored on RFID tags associated with or coupled to certain objects or locations. When first responders arrive at the scene of an emergency, using an RFID reader the first responder can retrieve the information stored on the RFID tag(s) and receive specific information to help respond to the emergency in a safer, more efficient manner.

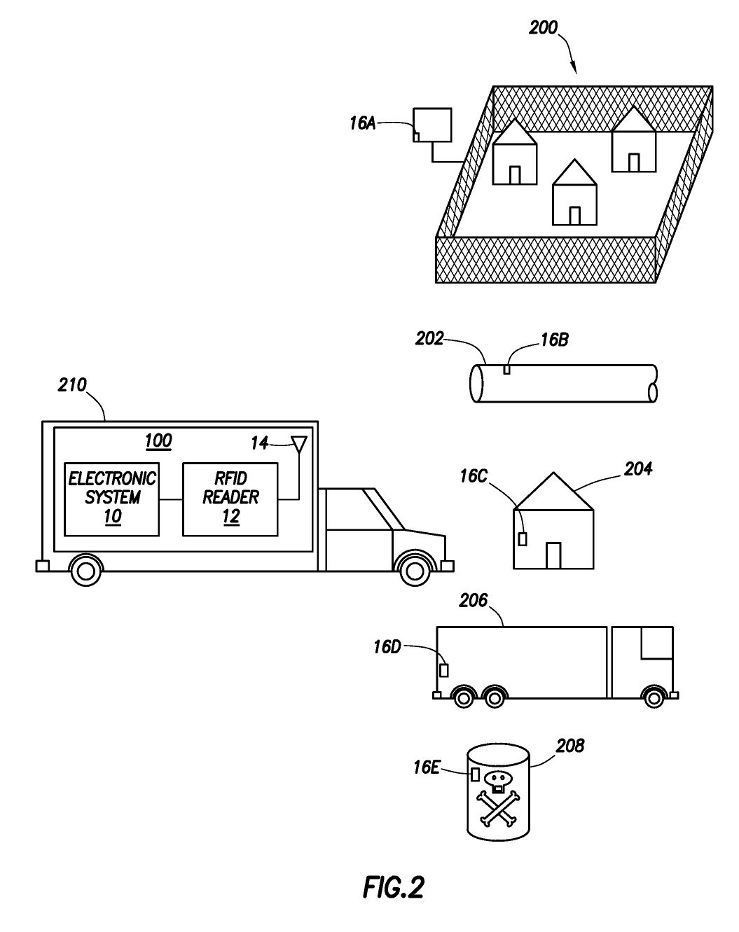

FIG. 2 illustrates a plurality of potential uses of RFID tags in emergency situations in accordance with various embodiments. Consider, as an example, a situation where the first responders arrive at a compound 200, which has a RFID tag 16A placed just outside of the compound. In other embodiments, the RFID tag 16A may be placed within the compound, or otherwise associated with the compound. Using an RFID reader system 100, comprising the electronic system 10 coupled to the RFID reader 12 and antenna 14 (hereafter just reader system 100) in an emergency vehicle 210, the first responders read the RFID tag 1 6A and retrieve information concerning the compound. In other embodiments, the RFID tag 16A may be read by a hand-held RFID reader. The information the first responders retrieve may take many forms. In some embodiments, the first responders may retrieve the layout of the compound. In other embodiments, the first responders may retrieve structural maps and information regarding the buildings within the compound (e.g., the purpose of each building and the objects that may be stored in each building).

In yet still other embodiments, RFID tags may be placed in various geographical locations in and around the compound, with information regarding the particular geographic area stored on each RFID tag. The information on the RFID tags could comprise maps of the area, hazards within the area (both natural and manmade), or if the information is too voluminous to be stored on the RFID tag, the RFID tag could comprise links to the information. The RFID tag could also comprise plant, animal and/or wildlife information, such as venomous species and treatment and precautionary measures pertaining to those species.

Still referring to FIG. 2, now consider a situation of a RFID tag 16B placed on or otherwise associated with a pipeline 202. Upon arriving at an emergency involving the pipeline, first responders retrieve data from the RFID tag 16B by using the hand-held or vehicle mounted reader system 100. In these embodiments, the memory of the RFID tag 16B comprises information associated with pipeline. For example, the RFID tag may comprise a map of the pipeline showing where the pipeline is located, as well as other useful information such as the location of shutoff valves and access points. The RFID tag may also comprise structural information regarding the size and pressure specifications of the pipeline. Other useful information may be the contents of the pipeline and any treatment or precautionary measures that may need to be taken with regard to exposure and/or release of the contents of the pipeline. If the information is too voluminous, rather than storing the information directly, the RFID tag 16B may contain data that comprises a link to the information. Some embodiments of the link may comprise a link to a world-wide web address that contains the information or directions on where to find the information.

Still referring to FIG. 2, now consider a situation of a RFID tag 16C coupled to or associated with a single building 204. Upon arriving at an emergency involving the building 204, first responders retrieve data from the RFID tag 16C using the hand-held or vehicle mounted reader system 100. The memory of the RFID tag 16C may comprise structural information pertaining to the building. For example the RFID tag could comprise floor plans and materials used in the construction of the building. It may also comprise information pertaining to the contents of the building and any treatment or precautionary measures regarding the contents of the building. If the information is too voluminous, rather than storing the information directly, the RFID tag 16C may contain data that comprises a link to the information. Some embodiments of the link may comprise a link to a world-wide web address that contains the information or directions on where to find the information.

Still referring to FIG. 2, now consider a RFID tag 16D coupled to or associated with an object used for transportation, such as the tractor-trailer 206. Upon arriving at the emergency involving the tractor-trailer 206, first responders retrieve data from the RFID tag 16D using the hand-held or vehicle mounted reader system 100. The memory of tag 16D may comprise information regarding the contents transported by the truck. The information regarding the contents may comprise information regarding treatment and precautionary measures to be taken with regards to the contents of the truck. In other embodiments the memory of RFID tag 16D could comprise certain structural and design elements of the truck itself, and any precautionary measures that may need to be taken with regards to these elements. If the information is too voluminous, rather than store the information directly to the RFID tag, the RFID tag 16D may contain a link to the information. Some embodiments of the link may comprise a link to a world-wide web address that contains the information or directions on where to find the information. A tractor-trailer is merely illustrative, and the various embodiments may be applicable to any mobile system to transport goods (e.g. ship, airplane, shipping container or train). In yet other embodiments the memory of RFID tag 16D may comprise information regarding passenger vehicles. For example, the memory of the RFID tag may directly store or line to information such as the materials of which the vehicle is made, the optimal manner in removing trapped passengers, or avoiding other dangers (e.g. information on how to avoid cutting high electrical current cables in hybrid automobiles).

Still referring to FIG. 2, another embodiment may comprise writing information to a RFID tag 16E associated with or coupled to a container 208 of hazardous materials. Upon arriving at the emergency involving containers, first responders may retrieve data from the RFID tag 16E using either the hand-held or vehicle mounted reader system 100. The memory of RFID tag 16E could comprise data found within a Material Safety Data Sheet (MSDS), such as the name of the material, the manufacturer of the material, and treatment and precautionary measures in case of exposure and/or release of the material stored within the container. If the information is too voluminous, rather than store the information directly to the RFID tag, the RFID tag 16E may contain data that comprises a link to the information. Some embodiments of the link may comprise a link to a world-wide web address that contains the information or directions on where to find the information.

FIG. 3 illustrates a method in accordance with at least some embodiments. In particular, the method starts (block 300) and proceeds with writing the emergency information onto the RFID tag (block 302). In some embodiments where the memory of the RFID tag is of sufficient size, the information may be written directly to the RFID tag. In other embodiments where the RFID tag memory is relatively small or the information is voluminous, data pointing to the location of the information may be written to the RFID tag memory. Skipping for now blocks 304, 306, 308 and 310, the RFID tag may be placed (block 312) in the area with which the emergency information is to be associated, and the illustrative method ends (block 314). For example, a RFID tag with data pertaining to the structural information of a building may be placed at the entrance to that building, a RFID tag with data pertaining to a pipeline may be placed on a sign that indicates a pipeline is present, or a RFID tag with data pertaining to a hazardous material may be placed directly on the container storing the hazardous material.

With the increased use of RFID tags in society, it is possible the emergency responders may be proximate to RFID tags that do not contain emergency information. Thus, in some embodiments it may be desirable to write an indication to the memory of the RFID tag to identify that the tag contains emergency information. Returning to block 304, when writing to the memory of the RFID tags a decision is made whether to write an identifier to the RFID tag that indicates the tag contains emergency information (block 304). If so, then the identifier is written to the memory (block 306).

In some cases, the information written to the RFID tag that is useful to a first responder may be of a sensitive nature. Thus, in some embodiments it may be desirable to encrypt or otherwise limit access to the emergency information. Returning to block 308, when writing to the RFID tag a decision is made a decision is made whether to encrypt the information (block 308). If so, the information is encrypted (block 310). By encrypting or otherwise limiting access, the information may be retrieved only by those that have the decryption or access codes, such as the first responders. Although encrypting is shown to follow the decisions regarding writing of an indication that the tag comprises emergency information, encryption may be used regardless of whether the indication that the tag comprises emergency information is used.

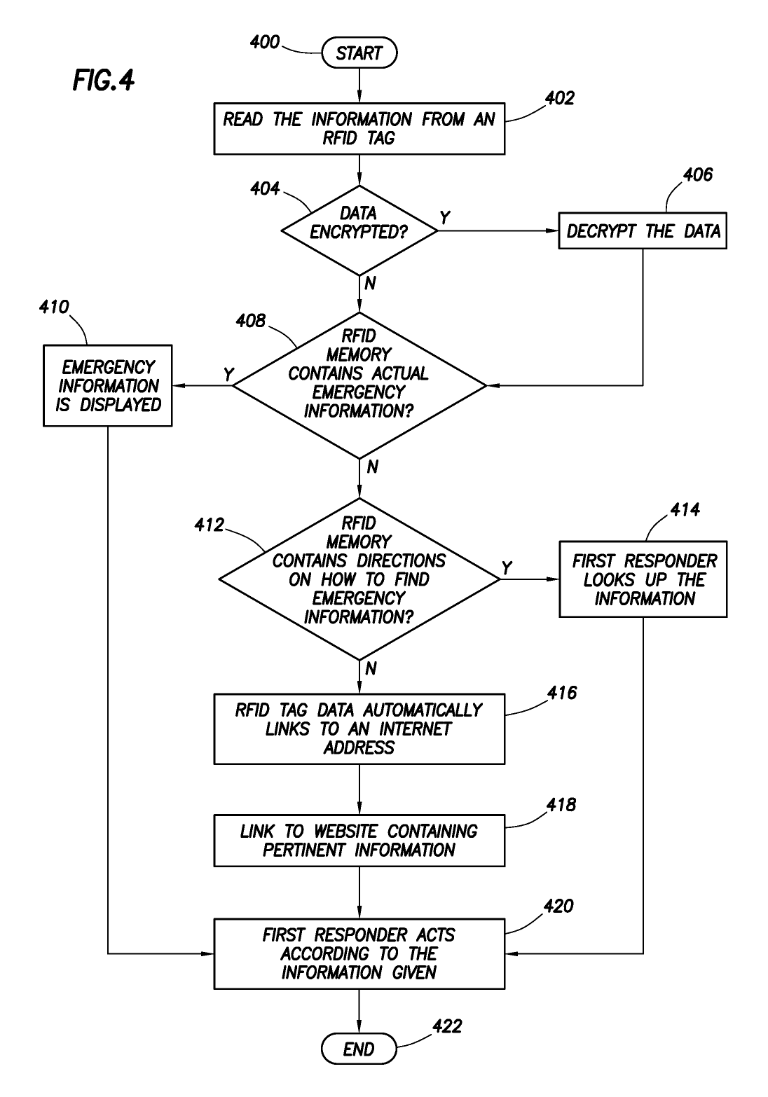

FIG. 4 illustrates yet still further methods in accordance with at least some of the embodiments. In particular, the method starts (block 400) and proceeds to reading a RFID tag (block 402). The reading may be, for example, by way of a hand-held or vehicle-mounted RFID reader. After reading, a determination is made as to whether the emergency information on the RFID tag is encrypted (block 404). If the information is encrypted, the information is decrypted (block 406). In embodiments where it is known in advance that encryption is not used, the decision block 404 and decryption of block 406 may be omitted. Following the decryption (if any), the illustrative method proceeds to determining if the RFID data comprises the actual emergency information (block 408). In embodiments where the data on the RFID tag does comprise the actual information, that information is displayed (block 410). The first responder acts according to the information given (block 420), and the illustrative method ends (block 422).

There are situations where the amount of information used by a first responder is too voluminous to store directly to the memory of a RFID tag. In these situations the RFID tag data may comprise information that indicates to the first responders where to physically locate the emergency information. Thus, if the RFID tag does not directly store the information (block 408), a determination is made as to whether the RFID tag contains direction on how to physically locate the desired information (block 412). If the RFID tag stores information in the form of how to physically locate the desired information, the first responder may find the emergency information pursuant to the data given (block 414). For example, the data on the RFID tag may direct the first responder to a physical location proximate to the emergency where the information is located, or the RFID tag may direct the first responder to a particular page or section of a standards manual on treating chemical exposure/release. Using the information, the first responder may act accordingly (block 420), and again the illustrative method ends (block 422).

Still considering the situation where the information to be conveyed is too voluminous to store directly to the memory of a RFID tag, if the RFID tag does not contain directions on how to find the information (again block 412), then the RFID tag may comprise a link to electronically find the information (block 416), such as a link to a world-wide web address accessible by way of the Internet. In embodiments using a link, the data of the RFID tag directly links the first responder to a website which contains the emergency information (block 418). The first responder may act according to the information given on the website (block 420), and again the illustrative method ends (block 422).

The above discussion is meant to be illustrative of the principles and various embodiments of the present invention. Numerous variations and modifications will become apparent to those skilled in the art once the above disclosure is fully appreciated. For example, the emergency information on the RFID tags may need to be updated from time to time, therefore some of the tags that have already been placed, may have updated emergency information written to them. Also the RFID tag information may be sent to emergency personnel not present at the scene of the emergency, and those personnel may then convey the information to the first responders. It is intended that the following claims be interpreted to embrace all such variations and modifications.

What is claimed is:

1. A method comprising:
writing emergency information to a radio frequency identification (RFID) tag; and
enabling a first responder to read the emergency information in an emergency situation.

2. The method according to claim 1 wherein writing the RFID tag further comprises writing the RFID tag that is at least one selected from the group consisting of: associated with an object; and coupled to the object.

3. The method according to claim 1 wherein writing the RFID tag further comprises writing the RFID tag that is at least one selected from the group consisting of: associated with a geographical area; and coupled to the geographical area.

4. The method according to claim 1 wherein writing the RFID tag further comprises writing the RFID tag that is at least one selected from the group consisting of: associated with a structure; and coupled to the structure.

5. The method according to claim 1 wherein writing the RFID tag further comprises writing the RFID tag that is at least one selected from the group consisting of: associated with a pipeline; and coupled to the pipeline.

6. The method according to claim 1 wherein writing the RFID tag further comprises writing the RFID tag that is at least one selected from the group consisting of: associated with a container; and coupled to the container.

7. The method according to claim 1 wherein writing the RFID tag further comprises writing the RFID tag that is at least one selected from the group consisting of: associated with an object used for transportation; and coupled to the object used for transportation.

8. The method according to claim 1 wherein writing the RFID tag further comprises encrypting the information on the RFID tag.

9. The method according to claim 1 wherein writing the RFID tag further comprises a value that indicates the RFID tag contains emergency information.

10. The method according to claim 1 wherein enabling further comprises enabling the first responder to read the RFID tag by at least one selected from the group consisting of: an RFID reader coupled to a vehicle; and an RFID reader carried by an individual.

11. The method according to claim 1 wherein enabling further comprises affixing the RFID tag to a surface in proximity of an object to which the emergency information is applicable.

12. A radio frequency identification (RFID) tag comprising:
a tag antenna; and
an RFID circuit coupled to the tag antenna, the RFID circuit comprising a memory;
wherein the memory of the RFID circuit holds emergency information being at least one selected from the group consisting of: information indicative of Material Safety Data Sheet (MSDS) data for a chemical; and treatment information for exposure to a chemical.

13. The RFID tag according to claim 12 wherein the memory of the RFID circuit directly holds the emergency information.

14. The RFID tag according to claim 12 wherein the memory of the RFID circuit holds data pointing to the location of the emergency information.

15. The RFID tag according to claim 12 wherein the memory of the RFID circuit holds a world-wide-web address that contains the emergency information.

16. A radio frequency identification (RFID) tag comprising:
a tag antenna; and
an RFID circuit coupled to the tag antenna, the RFID circuit comprising a memory;
wherein the memory of the RFID circuit holds emergency information, the emergency information being at least one selected from the group consisting of: information pertaining to a map of a building; and structural information of a building.

17. The RFID tag according to claim 16 wherein the memory further comprises the memory of the RFID circuit directly holds the emergency information.

18. The RFID tag according to claim 16 wherein the memory of the RFID circuit holds data pointing to the emergency information.

19. The RFID tag according to claim 16 wherein the memory of the RFID circuit holds a world-wide-web address having the emergency information.

20. A radio frequency identification (RFID) tag comprising:
a tag antenna; and
an RFID circuit coupled to the tag antenna, the RFID circuit comprising a memory;
wherein the memory of the RFID circuit holds emergency information, the emergency comprising structural information.

21. The RFID tag according to claim 20 wherein the memory further comprises the memory of the RFID circuit directly holds the emergency information.

22. The RFID tag according to claim 20 wherein the memory of the RFID circuit holds data pointing to the emergency information.

23. The RFID tag according to claim 20 wherein the memory of the RFID circuit holds a world-wide-web address having the emergency information.
